(19) United States
(12) Patent Application Publication
(10) Pub. No.: US 2026/0322032 A1
(43) Pub. Date: Oct. 15, 2026

(54) CONNECTOR

(71) Applicant: Yazaki Corporation, Tokyo (JP)

(72) Inventor: Yoshifumi SHINMI, Shizuoka (JP)

(73) Assignee: Yazaki Corporation, Tokyo (JP)

(21) Appl. No.: 19/638,258

(22) Filed: Apr. 3, 2026

(30) Foreign Application Priority Data
Apr. 10, 2025 (JP) 2025-064879

(51) Int. Cl. H01R 13/621; H01R 13/502; H01R 13/6581; H01R 24/28; H01R 105/00

(52) U.S. Cl. CPC H01R 13/6215; H01R 13/502; H01R 13/6581; H01R 24/28; H01R 2105/00; H01R 2201/26

(57) ABSTRACT

A connector includes an outer housing and an upper shell that includes a shell main body covering at least a part of the outer housing along a connection direction toward a mating connector. The upper shell includes a first attaching portion and a second attaching portion, each of which is attached to an attached portion of the mating connector by fastening using an attachment bolt. The attaching portions protrude from the shell main body in a direction orthogonal to the connection direction and directions opposite to each other. For example, the first attaching portion includes a first fastening plate portion that includes a first through hole extending along the connection direction and allowing the attachment bolt to pass therethrough, and a first frame portion that protrudes along the connection direction from an edge portion of the first fastening plate portion.

### CROSS REFERENCE TO RELATED APPLICATION

The present application is based on, and claims priority from the Japanese Patent Application No. 2025-064879, filed on Apr. 10, 2025, the entire contents of which are incorporated herein by reference.

### TECHNICAL FIELD

The present disclosure relates to a connector.

### BACKGROUND

In the related art, there is a high-voltage connector that can be employed as an on-vehicle component for an electric vehicle or the like. In the high-voltage connector, a large current is conducted, and hence it is required to reduce a resistance value at a contact portion with a mating connector. Herein, for example, in order to secure high contact reliability, it is conceivable to increase a contact load at the contact portion between the connectors. However, increasing the contact load also means increasing an assembly load between the connectors, which may increase difficulty of an assembly operation. Accordingly, there is a connector including a shell as a structure body capable of assisting fitting between the connectors by bolt fastening.

JP 2013-186955 A discloses a technique relating to a device connector including a metallic shield shell that includes a shell main body to be connected to one split case by bolt fastening while covering a second housing during fitting between a first housing and the second housing. The shell main body includes two attachment portions, namely, a first attachment portion and a second attachment portion, as bolt fastening portions. In other words, the shell main body has a structure capable of assisting fitting between the first housing and the second housing by bolt fastening at the two attachment portions.

### SUMMARY OF THE INVENTION

In the device connector disclosed in JP 2013-186955 A, due to conditions relating to a shape or a position of the first attachment portion and the second attachment portion in the shell main body, it is assumed that, during bolt fastening at one or both of the attachment portions, for example, a large load is applied to a linking portion of the attachment portions. Further, depending on a magnitude of the load applied to the attachment portions, deformation may occur in the shell main body, which may consequently become a factor that hinders an assembly operation between the connectors.

An object of the present disclosure is to provide a connector capable of suppressing deformation of a shell including a bolt fastening portion that assists fitting with a mating connector.

A connector according to an embodiment includes a housing that supports a part to be fitted with the mating connector, and a shell that is formed of metal and includes a shell main body covering at least a part of the housing along a connection direction toward the mating connector, wherein the shell includes a pair of attaching portions, each of which is attached to an attached portion of the mating connector by fastening using an attachment bolt, the attaching portions protrude from the shell main body in a direction orthogonal to the connection direction and directions opposite to each other, and each of the attaching portions includes a fastening plate portion that includes a through hole extending along the connection direction and allowing the attachment bolt to pass therethrough, and a frame portion that protrudes along the connection direction from an edge portion of the fastening plate portion.

According to the above-mentioned configuration, it is possible to provide a connector capable of suppressing deformation of a shell including a bolt fastening portion that assists fitting with a mating connector.

### BRIEF DESCRIPTION OF THE DRAWINGS

FIG. 1 is a perspective view of a connector according to a first embodiment.

FIG. 2 is an exploded perspective view of the connector according to the first embodiment.

FIG. 3 is a perspective view of an upper shell provided to the connector according to the first embodiment.

FIG. 4 is a front view of the upper shell provided to the connector according to the first embodiment.

FIG. 5 is a side view for describing a state of the upper shell during bolt fastening.

FIG. 6 is a perspective view of an upper shell provided to a connector according to a second embodiment.

FIG. 7 is a side view for describing a reaction force that may be generated in the upper shell during bolt fastening.

### DETAILED DESCRIPTION OF THE INVENTION

With reference to the drawings, a connector according to each embodiment is described below in detail. Note that the dimensional ratios in the drawings are exaggerated for explanatory purposes, and may differ from the actual ratios.

### First Embodiment

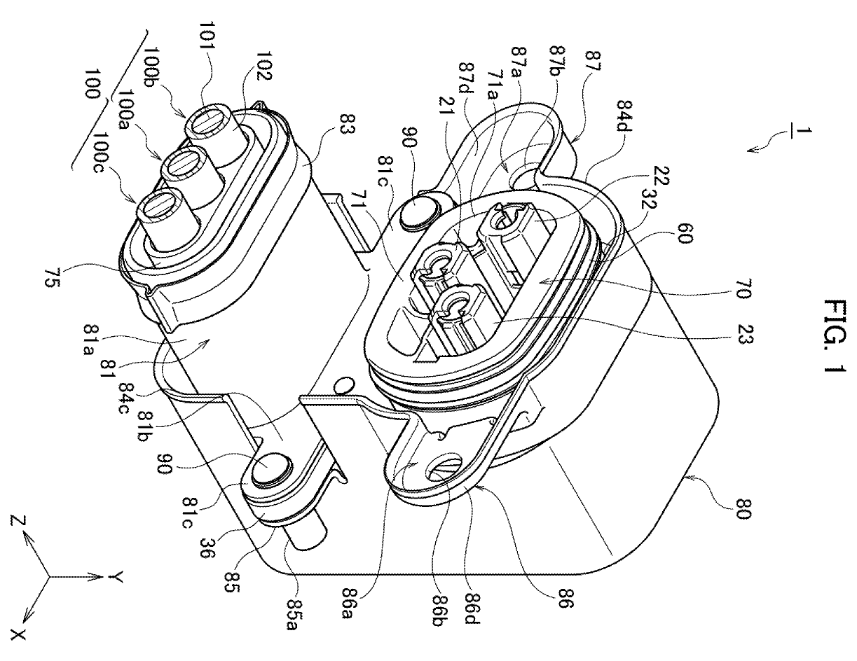

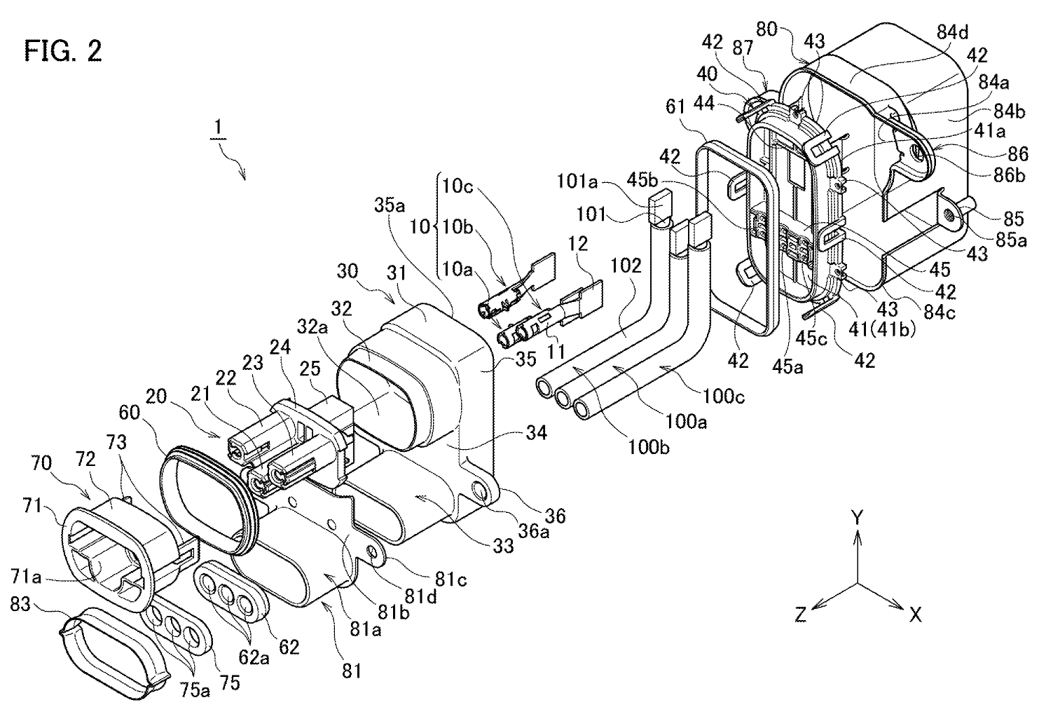

FIG. 1 is a perspective view of a connector 1 according to a first embodiment. FIG. 2 is an exploded perspective view of the connector 1. The connector 1 is, for example, a high-voltage connector that can be employed in a power supply system of a rear motor mounted on an electric vehicle or a hybrid vehicle. In the present embodiment, the connector 1 is assumed to be attached to a power supply system of a three-phase motor (omitted in illustration) as the rear motor. Further, an external connector to be fitted with the connector 1 is referred to as a “mating connector”.

As the power supply system of the three-phase motor, three electric wires 100, namely, a first electric wire 100a, a second electric wire 100b, and a third electric wire 100c are provided in advance. The first electric wire 100a is an electric wire for a U-phase. The second electric wire 100b is an electric wire for a V-phase. The third electric wire 100c is an electric wire for a W-phase. Each of the electric wires 100 includes a core wire 101 being a conductor and a covering portion 102 being an insulating body covering the core wire 101. One wire end of the electric wire 100 is connected to the three-phase motor, and the other wire end of the electric wire 100 is connected to the connector 1. Note that, although the core wire 101 may be formed by a plurality of element wires in actuality, the core wire 101 is illustrated as one conductive wire member in a simplified manner in FIGS. 1 and 2. Further, in each of the electric wires 100, at the wire end connected to the connector 1, the covering portion 102 is removed, and a wire end portion 101a of the core wire 101 is exposed.

The connector 1 first includes, as a group of constituent elements relating to electrical connection, a plurality of terminals 10, an inner housing 20, an outer housing 30, and a rear cover 40.

In the present embodiment, as the plurality of terminals 10, three terminals 10 including a first terminal 10a, a second terminal 10b, and a third terminal 10c corresponding to the three-phase motor are provided. The first terminal 10a is attached to the wire end of the first electric wire 100a. The second terminal 10b is attached to the wire end of the second electric wire 100b. The third terminal 10c is attached to the wire end of the third electric wire 100c.

The three terminals 10 are metal female terminals each having an identical shape, and each include a connection portion 11 and a joint portion 12.

The connection portion 11 is a cylindrical portion into which a rod-shaped male terminal serving as an external terminal of the mating connector is insertable. The connection portion 11 includes a plate spring portion that presses a part of the male terminal against an inner wall portion of the connection portion 11 in order to stably maintain an electrically conductive state with the male terminal inserted therein.

The joint portion 12 is a flat plate portion that joins the wire end portion 101a of the core wire 101. It is assumed that one end portion of the connection portion 11 in an axis direction serves as an opening end through which the male terminal is inserted, and the joint portion 12 is integrated with the other end portion of the connection portion 11 in the axis direction. In the present embodiment, when the terminal 10 is installed in the connector 1, the axis direction of the connection portion 11 extends along a Z direction. One surface of the joint portion 12 is a joint surface to which the wire end portion 101a is joined by ultrasonic joining, for example. The other surface of the joint portion 12 is an open surface to which no component is joined.

Herein, for each of the terminals 10, a direction extending from the joint portion 12 toward the connection portion 11 along the axis direction of the connection portion 11 is shifted by 90 degrees from a direction extending from the wire end portion 101a on the joint portion 12 toward a main body of the electric wire 100. In other words, in a case in which the terminal 10 is installed in the connector 1, when the axis direction of the connection portion 11 extends along the Z direction, the wire end portion 101a is arranged in a posture extending along the wire end portion 101a on the one surface of the joint portion 12. In this state, when the wire end portion 101a on the joint portion 12 is taken as a starting point, each of the electric wires 100 extends from the wire end portion 101a in a direction opposite to the Y direction.

The inner housing 20 is formed of, for example, a synthetic resin, and is an insulating member that protects the terminal 10 by holding the three terminals 10 inside. The inner housing 20 includes a first terminal accommodation portion 21, a second terminal accommodation portion 22, a third terminal accommodation portion 23, a base portion 24, and a reinforcing structure portion 25.

The first terminal accommodation portion 21 is a cylindrical portion that accommodates the connection portion 11 of the first terminal 10a. The second terminal accommodation portion 22 is a cylindrical portion that accommodates the connection portion 11 of the second terminal 10b. The third terminal accommodation portion 23 is a cylindrical portion that accommodates the connection portion 11 of the third terminal 10c. Each of the first terminal accommodation portion 21, the second terminal accommodation portion 22, and the third terminal accommodation portion 23 accommodates the connection portion 11 so that an opening direction of the connection portion 11 accommodated inside, in other words, a direction opposite to a direction in which the male terminal is common as a direction extending along a first direction. In the present embodiment, the first direction is the Z direction. A distal end portion of each of the first terminal accommodation portion 21, the second terminal accommodation portion 22, and the third terminal accommodation portion 23 is opened in the first direction, and does not hinder entry of the male terminal into the connection portion 11.

Further, as an example, the first terminal accommodation portion 21, the second terminal accommodation portion 22, and the third terminal accommodation portion 23 are distributed and arranged in two tiers along the Y direction as a second direction, which is defined below. For example, the first terminal accommodation portion 21 may be arranged in a lower tier in the second direction, and the second terminal accommodation portion 22 and the third terminal accommodation portion 23 may be arranged in an upper tier in the second direction. In this state, in an X direction as a third direction, which is defined below, the first terminal accommodation portion 21 may be arranged at the intermediate position between the second terminal accommodation portion 22 and the third terminal accommodation portion 23.

The base portion 24 is a flat plate-shaped portion that supports the first terminal accommodation portion 21, the second terminal accommodation portion 22, and the third terminal accommodation portion 23. The internal space of each of the first terminal accommodation portion 21, the second terminal accommodation portion 22, and the third terminal accommodation portion 23 is open from a rear surface portion opposite to a front surface portion of the base portion 24, which supports those accommodation portions, in a direction opposite to the first direction.

The reinforcing structure portion 25 is a structure body formed by combining a plurality of reinforcing ribs in order to secure strength of the inner housing 20. The reinforcing structure portion 25 is provided on the rear surface portion of the base portion 24 from which the internal space of each of the accommodation portions is open, so as not to hinder arrangement of the respective terminals 10 and the respective electric wires 100.

The outer housing 30 is formed of, for example, a synthetic resin, and is an insulating member that protects the three terminals 10 as a whole by accommodating at least a part of the inner housing 20 and the joint portion 12 of each of the terminals 10. The outer housing 30 includes a housing main body portion 31, a connector opening portion 32, and an electric wire lead-out portion 33.

The housing main body portion 31 is a box portion defined so that, when the first direction is a length direction, the second direction orthogonal to the first direction is a height direction, and the third direction orthogonal to both the first direction and the second direction is a width direction. In the present embodiment, as described above, the first direction is the Z direction, the second direction is the Y direction, and the third direction is the X direction. The housing main body portion 31 includes a front wall 34, an annular side wall 35, and a plurality of support pieces 36.

The front wall 34 is a wall portion orthogonal to the first direction, and supports the connector opening portion 32 and the electric wire lead-out portion 33 so that the connector opening portion 32 and the electric wire lead-out portion 33 are separated away from each other in the second direction. A planar shape of the front wall 34 is a substantially rectangular shape defined by long sides extending substantially along the second direction and short sides extending substantially along the third direction. Further, on a wall surface of the front wall 34, which faces an interior of the housing main body portion 31, although not shown, there is provided a first electric wire contact portion that faces a second electric wire contact portion 45 while being spaced apart from the second electric wire contact portion 45 when the rear cover 40, which is described later, is attached to the outer housing 30. A shape of the first electric wire contact portion is substantially symmetrical to a shape of the second electric wire contact portion 45 in the Z direction.

The annular side wall 35 together with the front wall 34 forms an internal space that accommodates at least the joint portion 12 of each of the terminals 10. One annular end of the annular side wall 35 in the first direction is continuous with a peripheral edge portion of the front wall 34. The other annular end of the annular side wall 35 in the first direction is an opening end 35a at which an opening facing the front wall 34 is formed. At the time of assembling the connector 1, the three terminals 10, each of which is attached to the wire end of the electric wire 100, are accommodated in the housing main body portion 31 through the opening formed at the opening end 35a.

The plurality of support pieces 36 are provided on an outer wall surface of the annular side wall 35, and each include a fitting hole 36a for fitting an annular collar, which is omitted in illustration. The fitting hole 36a passes through the support piece 36 along the first direction. In the present embodiment, a pair of support pieces 36 are provided so that the support pieces 36 extend along a straight line extending in the second direction and protrude in directions opposite to each other.

The connector opening portion 32 includes an opening 32a having an oblong hole-shaped cross section opened in the first direction, and is a cylindrical portion that is fitted with a part of the mating connector when the mating connector including the male terminal is connected to the connector 1. The connector opening portion 32 is provided to protrude from the front wall 34 of the housing main body portion 31 in the first direction. The opening 32a passes through between the outside of the outer housing 30 and the inside of the housing main body portion 31, and can accommodate the inner housing 20. In the oblong hole-shaped cross section of the opening 32a, the second direction is a longitudinal direction in conformity with the arrangement relationship of the first terminal accommodation portion 21, the second terminal accommodation portion 22, and the third terminal accommodation portion 23 in the inner housing 20.

The electric wire lead-out portion 33 is a cylindrical portion from which the three electric wires 100 are drawn from the inside of the housing main body portion 31 to the outside of the outer housing 30 through a through space having an oblong hole-shaped cross section opened in the first direction. The electric wire lead-out portion 33 is provided to protrude from the front wall 34 of the housing main body portion 31 in the first direction. In the oblong hole-shaped cross section of the through space, the second direction is a longitudinal direction so that the three electric wires 100 are arrayed in the second direction in conformity with the arrangement relationship of the first terminal accommodation portion 21, the second terminal accommodation portion 22, and the third terminal accommodation portion 23 in the inner housing 20.

In other words, according to the structure of the outer housing 30, in the connector 1, a direction in which the opening 32a of the connector opening portion 32 faces, in other words, a direction of connection with the mating connector and a direction in which the three electric wires 100 are drawn out from the electric wire lead-out portion 33 extend along the same direction. In the present embodiment, the direction in which the opening 32a of the connector opening portion 32 faces and the direction in which the three electric wires 100 are drawn out from the electric wire lead-out portion 33 extend along the first direction corresponding to the Z direction.

The rear cover 40 is formed of, for example, a synthetic resin, and is an insulating member that covers an opening at the opening end 35a in a state where each of the terminals 10, in which the wire end portion 101a is joined to the joint portion 12, is accommodated together with the wire end part of the electric wire 100 inside the housing main body portion 31 of the outer housing 30. The rear cover 40 includes a main body wall 41, a plurality of locking portions 42, a plurality of packing locking portions 43, a cover reinforcing rib 44 , and the second electric wire contact portion 45.

The main body wall 41 is a flat plate portion including an outer peripheral edge 41a extending along the opening end 35a of the housing main body portion 31 when the rear cover 40 is attached to the outer housing 30. An inner wall surface 41b of the main body wall 41 faces the front wall 34 of the housing main body portion 31 when the rear cover 40 is attached to the outer housing 30.

The plurality of locking portions 42 are provided at the outer peripheral edge 41a of the main body wall 41 at an interval in a circumferential direction along the outer peripheral edge 41a. At an outer surface portion of the annular side wall 35 of the housing main body portion 31, a plurality of engagement portions, which are omitted in illustration, are provided. When the rear cover 40 is attached to the outer housing 30, the respective locking portions 42 are engaged with the engagement portions provided to the annular side wall 35. With this, detachment of the rear cover 40 from the outer housing 30 is suppressed.

The plurality of packing locking portions 43 are provided at the outer peripheral edge 41a of the main body wall 41 at an interval in the circumferential direction along the outer peripheral edge 41a while avoiding the plurality of locking portions 42. At a rear cover packing 61 described later, a plurality of engagement protrusions, which are omitted in illustration, are provided. When the rear cover 40 is attached to the outer housing 30, the packing locking portions 43 are engaged with the engagement protrusions provided to the rear cover packing 61. With this, the rear cover 40 holds the rear cover packing 61.

In order to secure strength of the rear cover 40, the cover reinforcing rib 44 is provided to the inner wall surface 41b so as not to hinder arrangement of the respective terminals 10 and the respective electric wires 100.

The second electric wire contact portion 45 is provided to the inner wall surface 41b, and contacts with each of the electric wires 100 when the rear cover 40 is attached to the outer housing 30. The second electric wire contact portion 45 includes a first contact groove 45a, a second contact groove 45b, and a third contact groove 45c, each of which extends in the second direction and includes a curve surface matching with a side surface shape of each of the electric wires 100 routed inside the housing main body portion 31. The first contact groove 45a accommodates and contacts with a part of the side surface of the first electric wire 100a. The second contact groove 45b accommodates and contacts with a part of the side surface of the second electric wire 100b. The third contact groove 45c accommodates and contacts with a part of the side surface of the third electric wire 100c.

Herein, when the rear cover 40 is attached to the outer housing 30, the first contact groove 45a sandwiches the first electric wire 100a together with a corresponding contact groove provided in the housing main body portion 31. Similarly, the second contact groove 45b sandwiches the second electric wire 100b together with a corresponding contact groove provided in the housing main body portion 31. The third contact groove 45c sandwiches the third electric wire 100c together with a corresponding contact groove provided in the housing main body portion 31. In other words, the second electric wire contact portion 45 holds each of the electric wires 100 in combination with the first electric wire contact portion provided to the housing main body portion 31. With this, the second electric wire contact portion 45 forms an electric wire holding portion that suppresses vibration transmitted from the outside through the electric wire 100 from reaching the terminal 10.

Further, the connector 1 includes, as waterproof members for suppressing entry of moisture from the outside to the inside of the outer housing 30, a unit packing 60, the rear cover packing 61, and a wire packing 62.

The unit packing 60 is an annular elastic member that is tightly attached in conformity with an outer peripheral surface of the connector opening portion 32 of the outer housing 30. When the mating connector is connected to the connector 1, the unit packing 60 seals a space between an outer peripheral surface of the connector opening portion 32 and a fitting surface of the mating connector.

The rear cover packing 61 is an annular elastic member that is tightly attached in conformity with the opening end 35a of the housing main body portion 31 of the outer housing 30. When the rear cover 40 is attached to the outer housing 30, the rear cover packing 61 seals a space between the opening end 35a of the housing main body portion 31 and the outer peripheral edge 41a of the rear cover 40.

The wire packing 62 is an oblong flat plate-shaped elastic member that is tightly attached in conformity with an inner wall surface of the electric wire lead-out portion 33 of the outer housing 30. Further, the wire packing 62 includes three through holes 62a that closely contact with the respective electric wires 100 and allow the respective electric wires 100 to pass therethrough individually. The wire packing 62 seals a space between the inner wall surface of the electric wire lead-out portion 33 and each of the electric wires 100 passing through the through space of the electric wire lead-out portion 33.

Further, the connector 1 includes, as holding members for various packings, a front holder 70 and a rear holder 75.

The front holder 70 is formed of a synthetic resin, and is attached to the outer housing 30 so as to suppress detachment of the unit packing 60 from the connector opening portion 32. The front holder 70 includes a front plate 71, a cylindrical portion 72, and a plurality of locking portions 73.

The front plate 71 is a flange-shaped annular plate portion that is positioned at a distal end portion of the connector opening portion 32 when the front holder 70 is attached to the outer housing 30. The front plate 71 includes an opening portion 71a from which the first terminal accommodation portion 21, the second terminal accommodation portion 22, and the third terminal accommodation portion 23 of the inner housing 20 are exposed from the connector opening portion 32 to the outside. At least a part of an outer peripheral portion of the front plate 71 faces at least a part of the unit packing 60, which is attached to the connector opening portion 32, in the first direction when the front holder 70 is attached to the outer housing 30. Thus, even when the unit packing 60 moves to a distal end side of the connector opening portion 32, the unit packing 60 abuts against the front plate 71, and further movement thereof is regulated. With this, detachment from the connector opening portion 32 is suppressed.

The cylindrical portion 72 is accommodated in the opening 32a of the connector opening portion 32 when the front holder 70 is attached to the outer housing 30. One opening end of the cylindrical portion 72 is a fixed end continuous with the opening portion 71a of the front plate 71. The other opening end of the cylindrical portion 72 is an open end facing the inside of the housing main body portion 31 when the front holder 70 is attached to the outer housing 30. Note that a reinforcing structure portion for securing strength of the front holder 70 may be provided inside the cylindrical portion 72.

The plurality of locking portions 73 are provided to a part of the cylindrical portion 72 at an interval in a circumferential direction. At the outer surface portion of the annular side wall 35 of the housing main body portion 31 or an inner surface portion of the opening 32a of the connector opening portion 32, a plurality of engagement portions, which are omitted in illustration, are provided. The locking portions 73 are engaged, for example, with locking portions provided to the annular side wall 35 when the front holder 70 is attached to the outer housing 30. With this, detachment of the front holder 70 from the outer housing 30 is suppressed.

The rear holder 75 is formed of a synthetic resin, and is attached to the outer housing 30 so as to suppress detachment of the wire packing 62 from the electric wire lead-out portion 33. The rear holder 75 includes three through holes 75a that allow the respective electric wires 100 to pass therethrough individually, and is an oblong flat plate-shaped member similar to the shape of the wire packing 62. The rear holder 75 is inserted into the through space from a distal end side of the electric wire lead-out portion 33, and is supported by the electric wire lead-out portion 33 in a state where the wire packing 62 seals the space between the inner surface wall of the electric wire lead-out portion 33 and each of the electric wires 100. With this, the rear holder 75 suppresses detachment of the wire packing 62 from the electric wire lead-out portion 33.

Further, the connector 1 includes, as shield members for blocking noise, an upper shell 80, a lower shell 81, and a shield ring 83.

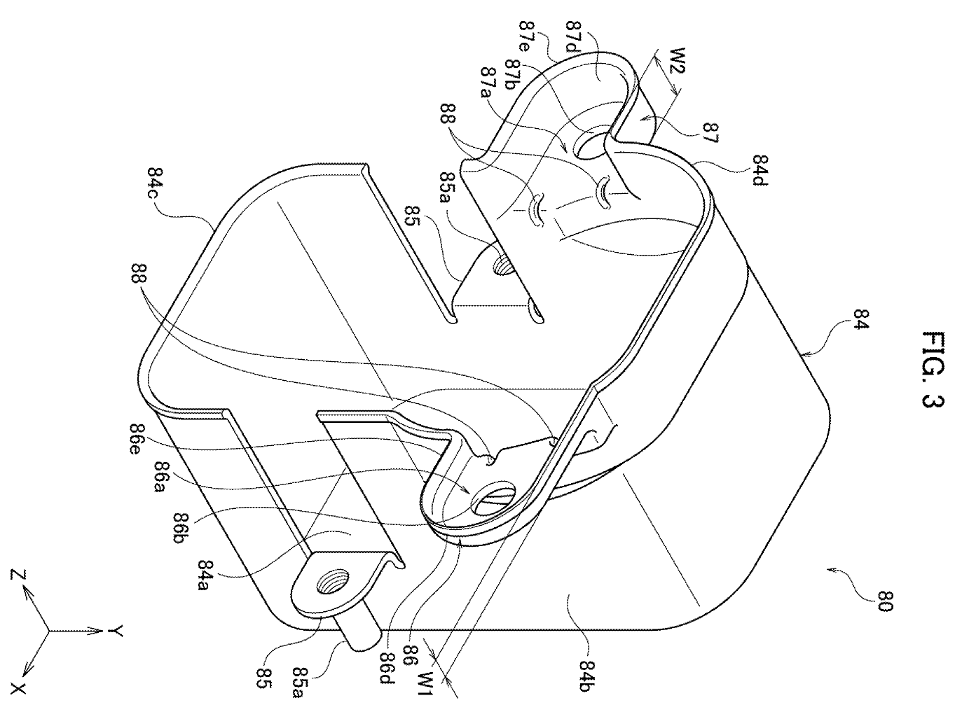

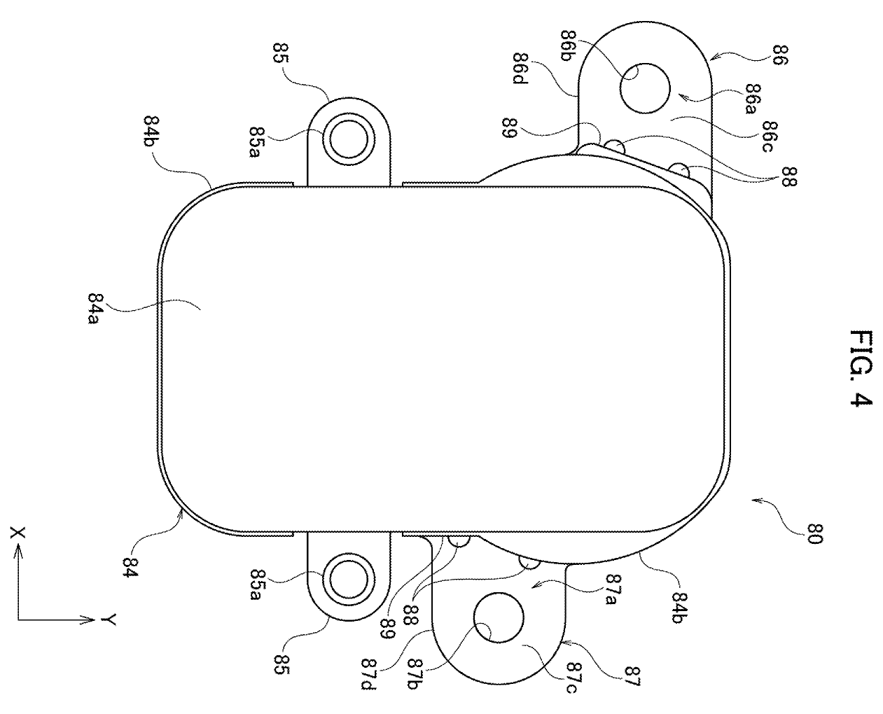

FIG. 3 is a perspective view of the upper shell 80. FIG. 4 is a front view of the upper shell 80 as viewed in the first direction.

The upper shell 80 is formed of metal, and covers the housing main body portion 31 to which the rear cover 40 is attached in the outer housing 30. Note that the upper shell 80 may cover at least a part of the connector opening portion 32 or the electric wire lead-out portion 33 of the outer housing 30 while accommodating the housing main body portion 31. The upper shell 80 includes a shell main body 84, a plurality of support pieces 85, and a first attaching portion 86 and a second attaching portion 87 as a pair of attaching portions.

The shell main body 84 is a box-shaped structure body that substantially covers the housing main body portion 31. In the present embodiment, the shell main body 84 is defined, in terms of an overall shape of the connector 1, so that the first direction corresponding to the Z direction is a length direction, the second direction corresponding to the Y direction is a height direction, and the third direction corresponding to the X direction is a width direction. Herein, the first direction also corresponds to a direction in which the shell main body 84 covers the housing main body portion 31, and also corresponds to a direction in which the connector 1 is connected to the mating connector. The shell main body 84 includes a bottom surface wall 84a and an annular side wall 84b.

The bottom surface wall 84a is a wall portion orthogonal to the first direction. A planar shape of the bottom surface wall 84a is substantially a rectangular shape defined by long sides extending substantially along the second direction and short sides extending substantially along the third direction.

The annular side wall 84b together with the bottom surface wall 84a forms an internal space that accommodates the housing main body portion 31. One annular end of the annular side wall 84b in the first direction is continuous with a peripheral edge portion of the bottom surface wall 84a. The other annular end of the annular side wall 84b in the first direction is an opening end 84c at which an opening facing the bottom surface wall 84a is formed. At the time of assembling the connector 1, the housing main body portion 31 to which the rear cover 40 is attached is accommodated through the opening formed at the opening end 84c. Further, at the opening end 84c, a part of a region close to an accommodation part of the connector opening portion 32 forms a fitting frame portion 84d having a shape extending along an oblong hole shape of the opening 32a of the connector opening portion 32.

The plurality of support pieces 85 are provided, for example, as parts formed by bending parts of the annular side wall 84b, and each include a fastening cylinder portion 85a to which a bolt 90 passing through the fitting hole 36a provided in the outer housing 30 is fastened at the time of assembling the connector 1. In other words, in the present embodiment, similarly to the support pieces 36 each including the fitting hole 36a, a pair of support pieces 85 are provided so that the support pieces 85 extend along a straight line extending in the third direction and protrude in directions opposite to each other. Note that the third direction is also a direction extending along a major axis of an oblong hole-shaped opening cross section of the opening 32a of the connector opening portion 32, which is a fitting portion of the connector 1, and is also a direction extending along a short side of the bottom surface wall 84a.

The first attaching portion 86 and the second attaching portion 87 are parts for attaching the upper shell 80 to attached portions being structure portions of the mating connector when the connector 1 is connected to the mating connector. Herein, the attached portions being structure portions of the mating connector are, for example, casing portions formed by a conductive material.

The first attaching portion 86 and the second attaching portion 87 protrude from the opening end 84c of the shell main body 84 in a direction orthogonal to a connection direction and in directions opposite to each other. In the present embodiment, the connection direction corresponds to the first direction corresponding to the Z direction, and hence the projection direction of the first attaching portion 86 corresponds to the third direction corresponding to the X direction, and the projection direction of the second attaching portion 87 corresponds to a direction opposite to the third direction, which is a direction opposite to the X direction. The first attaching portion 86 includes a first fastening plate portion 86a and a first frame portion 86d. Similarly, the second attaching portion 87 includes a second fastening plate portion 87a and a second frame portion 87d.

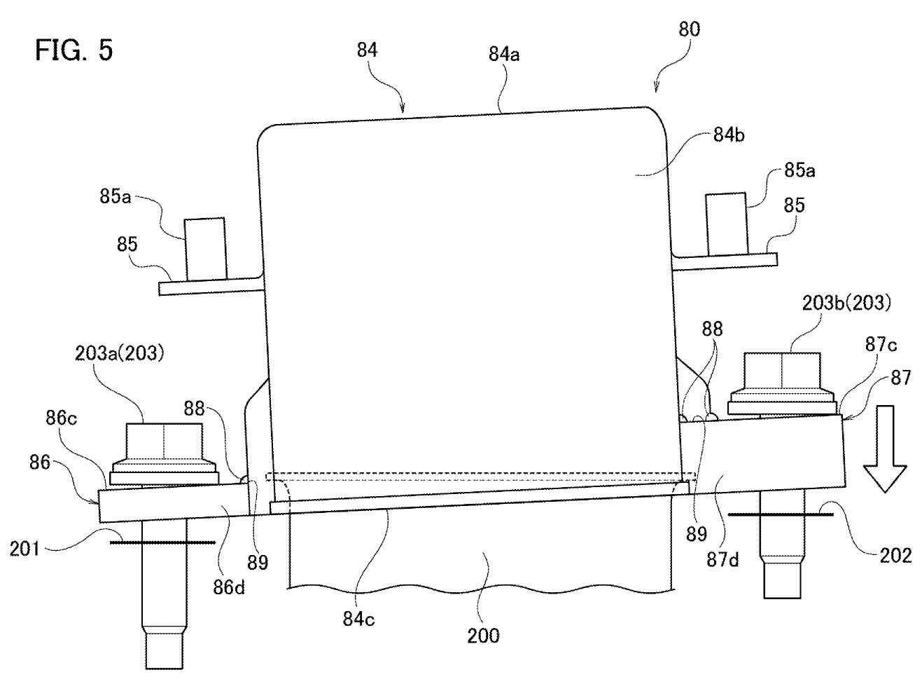

Each of the first fastening plate portion 86a and the second fastening plate portion 87a is a flat plate portion in which a through hole is formed, the through hole allowing an attachment bolt 203 used for attaching the upper shell 80 to the attached portion of the mating connector to pass therethrough. The first fastening plate portion 86a includes a first through hole 86b that allows a first attachment bolt 203a (see FIG. 5) to pass therethrough. Meanwhile, the second attaching portion 87 includes a second through hole 87b that allows a second attachment bolt 203b (see FIG. 5) to pass therethrough. The first through hole 86b and the second through hole 87b have the same opening diameter, and pass through along the first direction.

One main surface of the first fastening plate portion 86a is a first fastening surface 86c that includes, at least in part, a bolt fastening surface against which the first attachment bolt 203a presses at the time of fastening. Meanwhile, one main surface of the second fastening plate portion 87a is a second fastening surface 87c that includes, at least in part, a bolt fastening surface against which the second attachment bolt 203b presses at the time of fastening. The through directions of the respective through holes such as the first through hole 86b are set as the first direction, and hence the first fastening surface 86c and the second fastening surface 87c are parallel to each other along the XY plane.

A shape of a distal end edge of each of the first fastening plate portion 86a and the second fastening plate portion 87a is a part of a circle centered on the opening of each of the through holes as viewed in a direction along the through direction, for example. A root portion of each of the first fastening plate portion 86a and the second fastening plate portion 87a is linked, as a linking portion 89 with the shell main body 84, perpendicularly to the opening end 84c of the shell main body 84 or the fitting frame portion 84d being a part of the opening end 84c.

The first frame portion 86d and the second frame portion 87d protrude from edge portions of the corresponding fastening plate portions respectively along the connection direction. In other words, the first frame portion 86d protrudes the edge portion of the first fastening plate portion 86a, and the second frame portion 87d protrudes the edge portion of the second fastening plate portion 87a. In the first frame portion 86d, one end portion continuous with the edge portion of the first fastening plate portion 86a and the other end portion opposite to the one end portion in the connection direction are defined, and the other end portion is a distal end 86e being an open end. A position of the opening end 84c of the shell main body 84 and a position of the first distal end 86e match with each other in the connection direction. Meanwhile, in the second frame portion 87d, one end portion continuous with the edge portion of the second fastening plate portion 87a and the other end portion opposite to the one end portion in the connection direction are defined, and the other end portion is a second distal end 87e being an open end. The position of the opening end 84c of the shell main body 84 and a position of the second distal end 87e match with each other in the connection direction.

Further, the root portion of each of the first frame portion 86d and the second frame portion 87d is linked to the opening end 84c of the shell main body 84 or the fitting frame portion 84d being a part of the opening end 84c. In other words, the first frame portion 86d and the second frame portion 87d are parallel to any one of the parts of the annular side wall 84b of the shell main body 84.

Further, the first attaching portion 86 and the second attaching portion 87 also function as bolt fastening portions that assist fitting with the mating connector when the connector 1 is connected to the mating connector. Further, from a viewpoint of workability in attaching the upper shell 80 when exerting the function, a position of the first fastening surface 86c and a position of the second fastening surface 87c are different from each other in the first direction. In the present embodiment, the position of the first fastening surface 86c in the first direction is in front of the position of the second fastening surface 87c in the first direction. In this case, when the first attaching portion 86 and the second attaching portion 87 are attached to the attached portions of the mating connector by using the attachment bolts 203, the first attaching portion 86 may first be subjected to bolt fastening.

Herein, as described above, in the first direction, the position of the first distal end 86e and the position of the second distal end 87e match with the position of the opening end 84c of the shell main body 84. Further, in the first direction, the position of the first fastening surface 86c is in front of the position of the second fastening surface 87c. Thus, as illustrated in FIG. 3, a second width W2 being a width of the second attaching portion 87 in the first direction is larger than a first width W1 being a width of the first attaching portion 86 in the first direction. However, to be specific, the first width W1 is a width between the first fastening surface 86c and the first distal end 86e. Similarly, to be specific, the second width W2 is a width between the second fastening surface 87c and the second distal end 87e.

The upper shell 80 further includes at least one bead 88 at the linking portion 89 between the fastening plate portion of each of the attaching portions and the shell main body 84. Specifically, with regard to the first attaching portion 86, at least one bead 88 is provided at the linking portion 89 between the first fastening plate portion 86a and the shell main body 84. Similarly, with regard to the second attaching portion 87, the upper shell 80 includes at least one bead 88 at the linking portion 89 between the second fastening plate portion 87a and the shell main body 84. In the present embodiment, as an example, two beads 88 separated away from each other are formed at the respective linking portions 89 relating to the first attaching portion 86 and the second attaching portion 87.

The lower shell 81 is formed of metal, and covers a part of the front wall 34 of the housing main body portion 31 of the outer housing 30 and the electric wire lead-out portion 33. The lower shell 81 includes a cylindrical portion 81a, a flange portion 81b, and a plurality of support pieces 81c.

The cylindrical portion 81a covers the electric wire lead-out portion 33 by accommodating the electric wire lead-out portion 33 through the through space that is opened in the first direction and has an oblong hole-shaped cross section. One opening end of the cylindrical portion 81a is a fixed end continuous with the flange portion 81b. The other opening end of the cylindrical portion 81a is an open end forming an opening through which each of the electric wires 100 is drawn outward from the electric wire lead-out portion 33.

The flange portion 81b is a flat plate portion orthogonal to the first direction, and covers a part of the front wall 34 by facing the part of the front wall 34.

The plurality of support pieces 81c are provided as parts protruding outward from an edge portion of the flange portion 81b, and each include a through hole 81d that allows the bolt 90 to pass therethrough in advance so that the bolt 90 passes through the fitting hole 36a provided in the outer housing 30 at the time of assembling the connector 1. In other words, in the present embodiment, similarly to the support pieces 36 each including the fitting hole 36a, a pair of support pieces 81c are provided so that the support pieces 81c extend along a straight line extending in the X direction and protrude in directions opposite to each other.

The shield ring 83 is a metallic fastening member for crimping a shield braid, which is omitted in illustration, onto an outer peripheral surface of the cylindrical portion 81a of the lower shell 81. Note that the shield braid is a metallic braid, a part of which covers a distal end portion of the cylindrical portion 81a and another part of which is wound so as to integrally cover the three electric wires 100 drawn out from the cylindrical portion 81a.

The connector 1 further includes, as members for assembling the respective constituent elements, the plurality of bolts 90 and the plurality of collars (omitted in illustration), each of which is fitted in advance in the fitting hole 36a of the outer housing 30. The support piece 81c of the lower shell 81 is provided with the through hole 81d. The collar is fitted in the fitting hole 36a of the outer housing 30. Further, the support piece 85 of the upper shell 80 is provided with the cylinder portion 85a. The bolt 90 passes through the through hole 81d and the collar in the fitting hole 36a, and is fastened to the cylinder portion 85a. With this, the lower shell 81, the outer housing 30, and the upper shell 80 are assembled integrally to each other.

Next, actions and effects of the connector 1 according to the present embodiment are described.

The connector 1 is connected to the mating connector. The connector 1 includes the outer housing 30 being an example of a housing that supports a part to be fitted with the mating connector. Further, the connector 1 includes the upper shell 80 being an example of a shell that is formed of metal and includes the shell main body 84 covering at least a part of the outer housing 30 along the connection direction toward the mating connector. The upper shell 80 includes the first attaching portion 86 and the second attaching portion 87 being a pair of attaching portions, each of which is attached to the attached portion of the mating connector by fastening using the attachment bolt 203. Each of the attaching portions protrudes from the shell main body 84 in a direction orthogonal to the connection direction and directions opposite to each other. The attaching portion includes the fastening plate portion that includes the through hole extending along the connection direction and allowing the attachment bolt 203 to pass therethrough, and the frame portion that protrudes along the connection direction from the edge portion of the fastening plate portion.

Herein, in the example described above, the connection direction of the connector 1 with respect to the mating connector corresponds to the Z direction. The projection direction of the first attaching portion 86 extends along the X direction, and the projection direction of the second attaching portion 87 extends along the direction opposite to the X direction. Further, the first attaching portion 86 includes the first fastening plate portion 86a including the first through hole 86b, and the first frame portion 86d. Meanwhile, the second attaching portion 87 includes the second fastening plate portion 87a including the second through hole 87b, and the second frame portion 87d.

FIG. 5 is a schematic side view for describing a state of the upper shell 80 at the time of fastening using the attachment bolt 203. Herein, FIG. 5 is referred to describe an operation procedure of attaching the upper shell 80 to the mating connector when the connector 1 is connected to the mating connector. Thus, in FIG. 5, not all the constituent elements of the connector 1 are illustrated, and only the constituent elements necessary for the description are selectively illustrated. Meanwhile, in FIG. 5, the configuration of the mating connector is also schematically illustrated. First, as a part of the mating connector, a fitting portion 200 to be fitted with the connector 1 is schematically illustrated. Further, as the attached portions to which the first attaching portion 86 and the second attaching portion 87 are attached, a first attached surface 201 to which the first attaching portion 86 is attached and a second attached surface 202 to which the second attaching portion 87 is attached are illustrated schematically.

In a step of connecting the connector 1 to the mating connector, first, the fitting portion of the connector 1 is fitted with the fitting portion 200 of the mating connector. Note that the fitting portion of the connector 1 corresponds to a part including at least the connector opening portion 32 holding the front holder 70 in a state where the terminal accommodation portion such as the first terminal accommodation portion 21 is exposed through the opening portion 71a. Herein, since fitting between the fitting portions requires a large assembly load, fitting is not completed and a so-called temporary fitting state is established.

Subsequently, the first attaching portion 86 of the upper shell 80 is attached to the first attached surface 201. In other words, the first attachment bolt 203a that partially passes through the first through hole 86b is fastened to a bolt hole formed in the first attached surface 201, which is omitted in illustration. In this state, due to a fastening force by fastening of the first attachment bolt 203a, a fitting state between the fitting portions of the connector 1 and the mating connector progresses.

Subsequently, the second attaching portion 87 of the upper shell 80 is attached to the second attached surface 202. In other words, the second attachment bolt 203b that partially passes through the second through hole 87b is fastened to a bolt hole formed in the second attached surface 202, which is omitted in illustration, as indicated by the outlined arrow in FIG. 5. In this state, due to a fastening force by fastening of the second attachment bolt 203b, a fitting state between the fitting portions of the connector 1 and the mating connector progresses.

Finally, when bolt fastening by both the first attachment bolt 203a and the second attachment bolt 203b is completed, fitting between the fitting portions of the connector 1 and the mating connector is also completed, and thus the connector 1 is completely connected to the mating connector. In other words, even when a large assembly load is required for fitting between the fitting portions of the connector 1 and the mating connector, fitting is assisted by bolt fastening by the first attachment bolt 203a and the second attachment bolt 203b. Consequently, an assembly operation between the connectors is completed more easily.

Herein, as a comparative example, it is assumed that each of the pair of attaching portions is an attaching piece having a simple flat plate shape. In other words, it can be understood that the hypothetical attaching portion is configured only by the fastening plate portion such as the first fastening plate portion 86a without providing the frame portion such as the first frame portion 86d. In this case, for example, the linking portion between the hypothetical attaching portion and the shell main body 84 corresponds to a bent portion formed when bending is applied to a flat plate. Thus, when the shapes of the first attaching portion 86 and the like are similar to the shape of the hypothetical attaching portion, an increase in stress applied to the linking portion between the hypothetical attaching portion and the shell main body 84 during fastening of each bolt cannot be suppressed. As a result, deformation exceeding an allowable level may occur in the upper shell 80.

In contrast, in the connector 1 according to the present embodiment, each of the pair of attaching portions includes the fastening plate portion such as the first fastening plate portion 86a, and further includes the frame portion such as the first frame portion 86d that protrudes along the connection direction from the edge portion of the fastening plate portion. Thus, the frame portion functions as a reinforcing portion at the attaching portion, and hence strength in the connection direction corresponding to the fastening direction of the attachment bolt 203 is improved more as compared to a case in which the hypothetical attaching portion is adopted. Therefore, an increase in stress applied to the linking portion 98 between the attaching portion such as the first attaching portion 86 and the shell main body 84 during fastening of each bolt can be suppressed. As a result, deformation exceeding an allowable level is less likely to occur in the upper shell 80.

As described above, according to the present embodiment, it is possible to provide the connector 1 that suppresses deformation of the upper shell 80 including the bolt fastening portion that assists fitting with the mating connector. Further, according to the connector 1 described above, deformation of the upper shell 80 is suppressed. Thus, for example, it is advantageous in smoothly performing an assembly operation between the connectors or suppressing loosening of an axial force of the attachment bolt 203.

Further, in the connector 1, the shell main body 84 may include the opening end 84c being a distal end in the connection direction. The position of the opening end 84c of the shell main body 84 and the position of the distal end of the frame portion of the attaching portion may match with each other in the connection direction.

For example, the position of the opening end 84c of the shell main body 84 and the position of the first distal end 86e of the first frame portion 86d of the first attaching portion 86 may match with each other in the connection direction.

Similarly, the position of the opening end 84c of the shell main body 84 and the position of the second distal end 87e of the second frame portion 87d of the second attaching portion 87 may match with each other in the connection direction.

According to the connector 1, since no step in the connection direction is formed between the distal end such as the first distal end 86e and the opening end 84c, it is possible to reduce a part at which stress is likely to concentrate during bolt fastening. Thus, it is possible to further suppress an increase in stress applied to the linking portion.

Further, in the connector 1, the fastening plate portion may include the fastening surface against which the attachment bolt 203 presses. The position of the fastening surface of one fastening plate portion and the position of the fastening surface of the other fastening plate portion may be different from each other in the connection direction.

For example, in the first attaching portion 86, the first fastening plate portion 86a may include the first fastening surface 86c against which the first attachment bolt 203a presses during fastening. Similarly, in the second attaching portion 87, the second fastening plate portion 87a may include the second fastening surface 87c against which the second attachment bolt 203b presses during fastening. In this case, the position of the first fastening surface 86c provided to the first fastening plate portion 86a and the position of the second fastening surface 87c provided to the second fastening plate portion 87a may be different from each other in the connection direction.

Herein, in the example described above, the position of the first fastening surface 86c of the first attaching portion 86 in the connection direction is in front of the position of the second fastening surface 87c of the second attaching portion 87 in the connection direction.

According to the connector 1, as exemplified by referring to FIG. 5, bolt fastening at the first attaching portion 86 is first performed, and then bolt fastening at the second attaching portion 87 is performed. With this, the function of assisting fitting between the connectors can be exerted more stably.

Further, in the connector 1, the upper shell 80 may include at least one bead 88 at the linking portion 89 between the fastening plate portion and the shell main body 84.

For example, with regard to the first attaching portion 86, at least one bead 88 may be provided at the linking portion 89 between the first fastening plate portion 86a and the shell main body 84.

Similarly, with regard to the second attaching portion 87, at least one bead 88 may be provided at the linking portion 89 between the second fastening plate portion 87a and the shell main body 84.

According to the connector 1, since strength of the linking portion 89 is enhanced, an increase in stress applied to the linking portion 89 during fastening of each bolt can be further suppressed. As a result, deformation exceeding an allowable level is less likely to occur in the upper shell 80.

### Second Embodiment

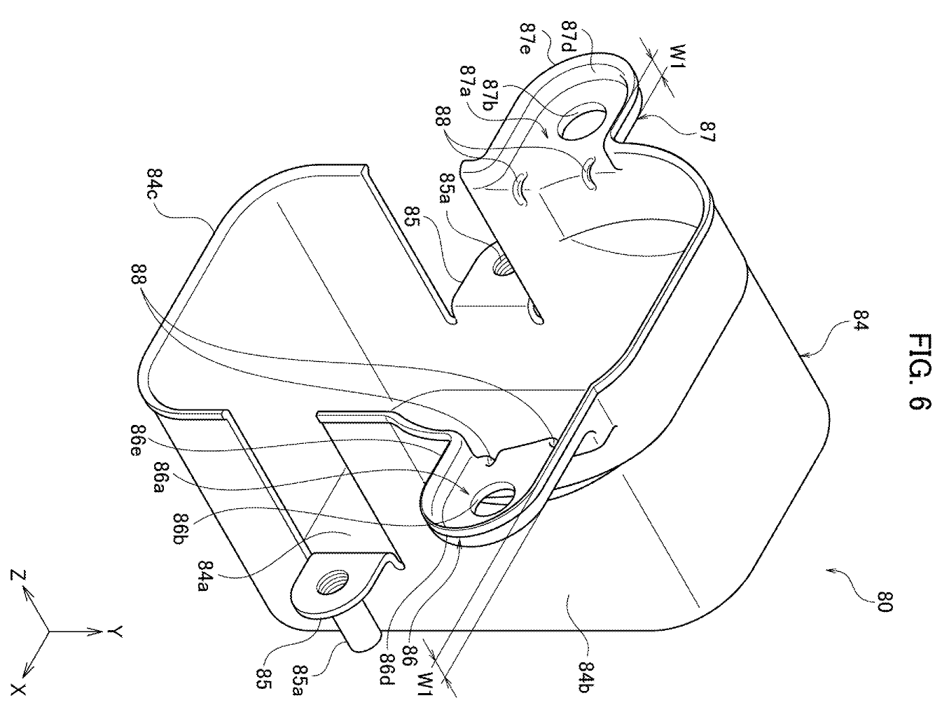

FIG. 6 is a perspective view of the upper shell 80 provided to the connector 1 according to a second embodiment. In FIG. 6, the upper shell 80 in the second embodiment is illustrated in accordance with the upper shell 80 in the first embodiment illustrated in FIG. 3.

In the connector 1 according to the first embodiment, as the structure of the upper shell 80, the position of the first fastening surface 86c provided to the first fastening plate portion 86a of the first attaching portion 86 and the position of the second fastening surface 87c provided to the second fastening plate portion 87a of the second attaching portion 87 are different from each other in the connection direction.

In contrast, in the connector 1 according to the second embodiment, the position of the first fastening surface 86c provided to the first fastening plate portion 86a and the position of the second fastening surface 87c provided to the second fastening plate portion 87a may match with each other in the connection direction.

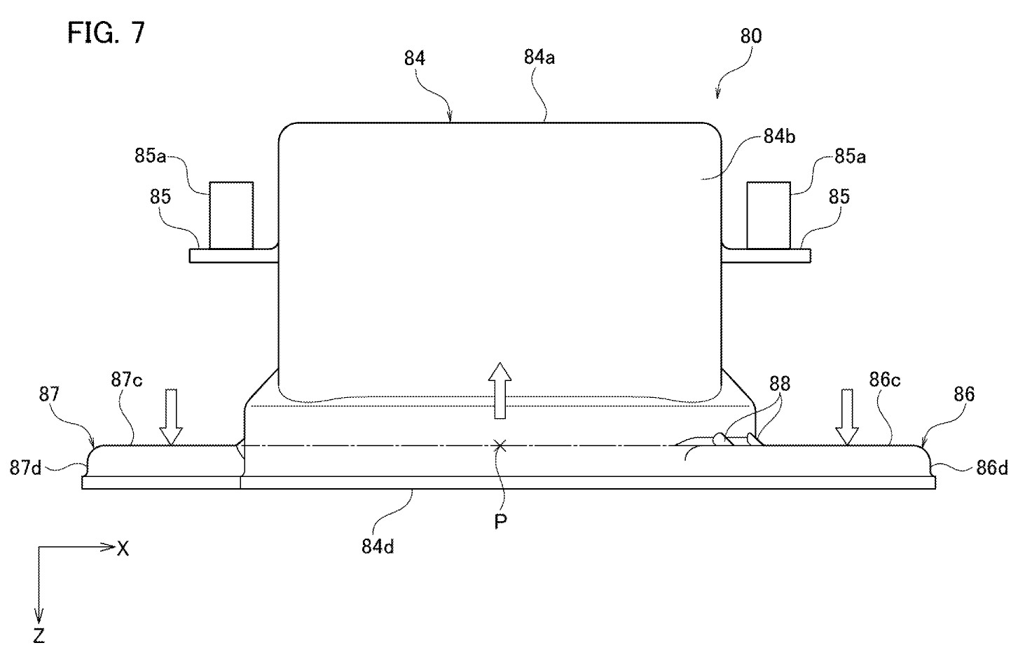

FIG. 7 is a side view for describing a reaction force that may be generated in the upper shell 80 during bolt fastening in the present embodiment. Note that, in FIG. 7, for simplicity of the description, the constituent elements other than the upper shell 80 are omitted in illustration.

In the connector 1 according to the present embodiment, the position of the first fastening surface 86c and the position of the second fastening surface 87c match with each other in the connection direction corresponding to the Z direction. In other words, the first fastening surface 86c and the second fastening surface 87c are flush with each other on a freely-selected plane defined as the XY plane. In this case, as illustrated in FIG. 7, during fastening of each bolt, a fulcrum P of a reaction force generated in the shell main body 84 in the connection direction is positioned on a region connecting the first fastening surface 86c and the second fastening surface 87c to each other. Thus, respective distances between a part that receives a fastening force at the first fastening surface 86c and the fulcrum P and between a part that receives a fastening force at the second fastening surface 87c and the fulcrum P are reduced, and hence a repulsion suppressing force is improved. Therefore, an increase in stress applied to the linking portion 89 during fastening of each bolt can be further suppressed. As a result, deformation exceeding an allowable level is less likely to occur in the upper shell 80.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A connector to be connected to a mating connector, the connector comprising:
a housing that supports a part to be fitted with the mating connector; and
a shell that is formed of metal and includes a shell main body covering at least a part of the housing along a connection direction toward the mating connector, wherein
the shell includes a pair of attaching portions, each of which is attached to an attached portion of the mating connector by fastening using an attachment bolt,
the attaching portions protrude from the shell main body in a direction orthogonal to the connection direction and directions opposite to each other, and
each of the attaching portions includes:
a fastening plate portion that includes a through hole extending along the connection direction and allowing the attachment bolt to pass therethrough; and
a frame portion that protrudes along the connection direction from an edge portion of the fastening plate portion.

2. The connector according to claim 1, wherein
the shell main body includes an opening end being a distal end in the connection direction, and
a position of the opening end of the shell main body and a position of a distal end of the frame portion of each of the attaching portions match with each other in the connection direction.

3. The connector according to claim 1, wherein
the fastening plate portion includes a fastening surface against which the attachment bolt presses during fastening, and
a position of the fastening surface of the fastening plate portion on one side and a position of the fastening surface of the fastening plate portion on the other side are different from each other in the connection direction.

4. The connector according to claim 1, wherein
the fastening plate portion includes a fastening surface against which the attachment bolt presses during fastening, and
a position of the fastening surface of the fastening plate portion on one side and a position of the fastening surface of the fastening plate portion on the other side match with each other in the connection direction.

5. The connector according to claim 1, wherein
the shell includes at least one bead at a linking portion between the fastening plate portion and the shell main body.
